(19) United States
(12) Patent Application Publication
(10) Pub. No.: US 2008/0287099 A1
(43) Pub. Date: Nov. 20, 2008

(54) SYSTEM AND METHOD FOR MANAGING CHARGES AND AIRTIME VALUES FOR CELLULAR PHONES AND ACCOUNTS

(76) Inventor: Moses Zonana, Dallas, TX (US)

Correspondence Address: Leason Ellis LLP, 81 Main Street, Suite 100, White Plains, NY, 10601, US

(21) Appl. No.: 12/120,604

(22) Filed: May 14, 2008

Related U.S. Application Data
(60) Provisional application No. 60/938,127, filed on May 15, 2007.
(60) Provisional application No. 60/940,068, filed on May 24, 2007.

(51) Int. Cl. H04M 15/06

(52) U.S. Cl. 455/408

(57) ABSTRACT

A system and method for managing calling values of calls to be charged to a call receiving party by associating a first code, such as a telephone number, inputted by a caller placing a call with the call receiving party at a call receiver platform and determining the amount that is to be charged to the call receiving party for the call by using rules associated with a second code supplied from the caller side when the call is placed. The call receiver has an account within a subscription system with a balance that is decremented by the charge for the call as determined by the rules associated with the second code. In a related aspect, a different subscriber can accept the charges for calls placed to certain call-receiving parties

### PRIORITY CLAIM

Priority is claimed under 35 USP §119 with respect to U.S. Provisional application Ser. No. 60/938,127 filed May 15, 2007 and U.S. provisional application Ser. No. 60/948,068 filed May 24, 2007, the disclosures of both said applications being incorporated herein in their respective entireties

### FIELD OF THE INVENTION

The present invention is directed to a system and method for managing airtime charges for cellular phones.

### BACKGROUND OF THE INVENTION

In recent years, mobile telecommunication, particularly mobile telephony using cellular telephones both in the private everyday life of users and within the context of managing business or organizational tasks, has become very important and commonplace. In conventional use of mobile communication systems in most countries of the world a party placing a call has an account that is charged based upon various factors that principally involve the number of airtime minutes used for a call. This can be billed on a per minute or other time unit basis at a fixed amount per minute or time unit or against a plan of a prepaid number of minutes or a post paid plan that operates on an allowance of minutes. In a few countries of the world the call receiving party has his account charged in a similar manner Systems in which the calling party pays for the entire cost of a call are somewhat restrictive in that they do not provide for the realities of current day personal situations and the manner in which many businesses are conducted in that often times the receiving party is willing to bear some or all the charges for the calls.

Various attempts have been made to provide a method and system in which a party calling from one region can call a party in the other region and have the call charged to the call receiving party.

U.S. Pat. No. 5,345,498 to Mauger provides a system in which the tariff employed for any particular call is determined by the location of the mobile subscriber involved in the call. A personal communication network number is used to determine location based billing information.

In U.S. Pat. No. 6,023,618 to Janhonen et al., a location number is provided within the format of the data message which provides the location of the subscriber to a mobile witching center (MSC). The MSC of the calling subscriber analyzes whether the location cell of the calling subscriber and/or that of the called subscriber are members of the group of special cells. If that is the case, the charging criteria determined for the group will be applied.

U.S. Pat. No. 6,327,466 to Savolainen disclose a method for setting the charge rate based on the origination zone and the destination zone of the call. A mobile phone part stores an updated location code for use in a tariff setting algorithm.

U.S. Pat. No. 6,954,630 to Offer describes a method for location-based billing for mobile telecommunications. The current cell identifier of a subscriber's mobile station is compared with a zone register managed by a network server to check for the subscriber's presence within a special billing zone.

However none of these references provides a user with a system or method of associating, at a wireless platform of call receivers, a cellular call to a receiving region from an originating region with a predetermined identification code. Also, none of these patents disclose a method or system in which the charges associated with the call are decremented by using the balance associated with the receiving code. The present invention addresses one or more of these and other deficiencies in the art.

### BRIEF DESCRIPTION OF THE INVENTION

The present invention is directed to long-distance area to area or region to region automatic call-collect charging to pre-paid and post-paid wireless subscribers. A wireless subscriber is a party that accepts charges for calls made to him. Such wireless subscribers include parties who have agreed to accept such chargeable calls as well as parties that dynamically become subscribers by purchasing call receiving telephone debit or credit cards or telephones and telephone numbers that are associated with the system. Also, subscribers can be prevented from receiving calls when the funds that they have made available to pay for calls are not sufficient. The invention is tailored to address party-to-party calling where charges are applied for the use of cellular airtime, and includes but is not limited to “International” or “Foreign” Automatic Call-Collect Charging or to Pre-Paid and Post-Paid Wireless Subscribers. The invention allows a receiver of a call on a pre-paid or a post-paid wireless program to pay for the charges of a call originated by a party wishing to reach the call receiver.

In a system and method in accordance with a broad aspect of the invention a caller places a call to a call receiving party subscriber associated with the system by using a code. In the context of the invention two codes are used. The first code can be the telephone number of the receiving party or a special code assigned to the call receiving party that identifies the call receiving party to whom the call is placed. The second code is associated with call charging rules that determine the amount to be billed to the call receiver for a call. Both codes are communicated to a platform that coordinates calls with billing information in furtherance of the objective of having the party receiving the call accepting charges for certain calls made to him.

In accordance with one aspect of the invention, a system and method of managing airtime values includes: using the first code for associating, at a wireless platform of the call receiving party subscribers, a call made to a receiving region from an originating region with the subscriber being in the receiving region; using the second code to determine the rules of how to determine the amount to be charged for the call; and decrementing the amount charged for the call from the balance of the account of the called subscriber. While the invention is described in terms of two codes, it should be understood that the two codes can be transmitted together, for instance, in a single sequence.

Callers who would be making such calls at no charge to a call receiver could be, for example and without limitation, a friend or family member of the call receiver. It also could be an employee of a company who works in a country different from a home office. It also could be a customer of a company in a different country who is given the privilege of making free calls to the company.

The second code can be a “dummy” number that identifies the country of origin from which the call is being made. In various embodiments of the invention the second code can be supplied to a caller by a call receiving party that wants the caller to call him without having to pay. The second code also can be appended by a service provider in the country from which the call is originated that operates from the caller's local number or an 800 number or other similar number that the caller dials in order to place the call.

These and other aspects, features, steps can be further appreciated from the following discussion of the invention in the context of certain embodiments thereof and as illustrated in the accompanying drawing figures.

### BRIEF DESCRIPTION OF THE DRAWINGS

Other objects and advantages of the present invention will become more apparent upon reference to the following specification and annexed drawings in which:

FIG. 1 is a diagram showing the overall communication path of the invention;

FIG. 2 is a diagram showing associating a code to a calling number to set the amount of charges for a call to be made to the call receiver;

FIG. 3 is a diagram showing the use of receiving party numbers to control access by a calling party to pre-designated receiving parties;

FIG. 4 is a diagram showing a calling party appending a dummy number to indicate origin of the call to the billing platform;

FIG. 5 is a diagram illustrating the checking of the account balance of a receiving party prior to call acceptance for charging; and

FIG. 6 is a diagram illustrating a variation of the system in which a call receiving party has an option to refuse a call.

### DETAILED DESCRIPTION OF CERTAIN EMBODIMENTS OF THE INVENTION

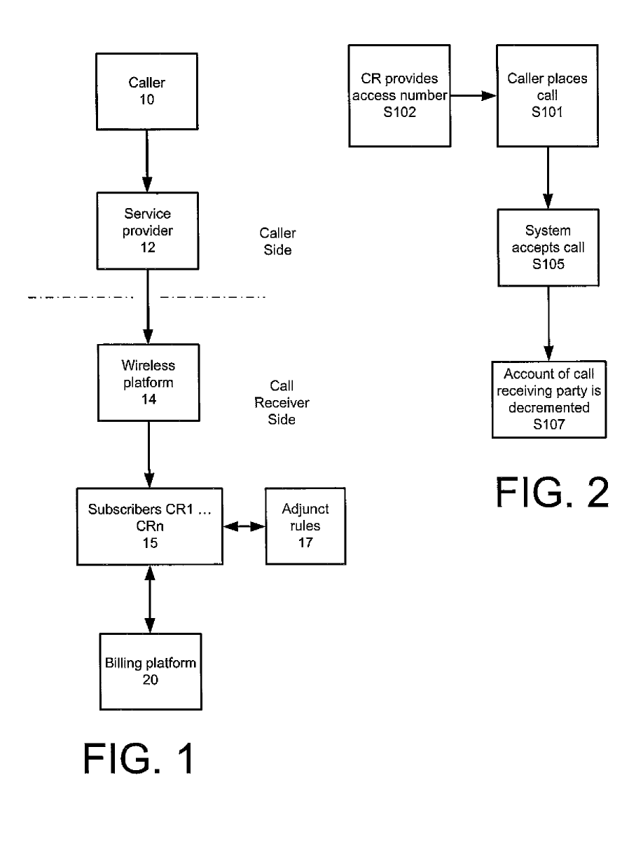

FIG. 1 shows the overall layout of the invention. On the caller side there is a caller 10 that is to place a call. The caller can place a call by any one of a cell phones land line phone, computer originated IP, VOIP, or any other available call communication technology. The call made at the caller side is processed and handled by a service provider 12 that communicates the call to the receiver side. On the call receiver side there is a wireless platform system 15 of subscribers CR1 . . . CRn, each of whom can accept the charges for calls made by callers 10 in another country or region. The makeup of the subscribers in the system 15 is dynamic in that subscribers become associated with the system by agreeing to accept charges, or by buying cards of various amounts that automatically associate them with the system 15, or by having a telephone that belongs to the subscriber base. A vendor can sell telephone numbers associated with the system to make a party purchasing such number a part of the subscriber base. Such party can use a telephone dedicated to the purchased system 15 number or have an incoming chargeable call forwarded to another telephone number with the charges being decremented against the subscriber system number. Also, an existing subscriber can be prevented from receiving chargeable calls when he does not have funds in his account that are sufficient to cover a charged call. Each of the subscribers CR1 . . . Crn is identified by a first code that is unique to him and which can be the number of his cell phone or any other unique number. Incoming calls to the system 15 are handled by a wireless platform 14 which performs service provider functions on the call receiving side.

Associated with the subscriber system 15 is a billing platform 20. The billing platform is a computer system that tracks the charges for each call made to a system subscriber Cr. The billing platform 20 can be managed by the wireless platform 14 manager or by another party. The call receiver billing platform 20 is programmed to charge calls against the account of an individual subscriber CR identified by the first code dialed by a caller. The account of the call receiving party is decremented by an amount determined using rules associated with the second code. For example, as determined by the second code, a call that is properly chargeable can be pre-paid meaning that there is a fixed charge to be made for the call. The received a call also can be charged on a post-paid basis, meaning that there can be per-minute, or other time unit charges. Pre-paid and post paid calls can be charged against a plan that has an allowed number of minutes over a given time period. There also can be any type of calling plans such as a fixed price over a period of days, different prices for call received from each of different countries, specific prices for calls received from specific calling numbers or calling areas, call charges based upon the time of day and/or days of the week, special promotional rate plans sold by a telephone company, etc. One or more of the above rules for charging a call is associated with the second code of an incoming call to a call receiver A call receiver can be charged under different rules for different incoming calls based on the second code associated with each such call. The charges for a call are billed against the call receiver's account at an appropriate time which can be before or after the call is completed depending upon the charging plan for the call.

In some instances, the call receiving party might be within a different billing wireless platform than that of the benefactor's wireless platform. In this instance, the call is channeled to the call-receiving party, as previously described, but through conventional messaging protocols, the second code is transmitted during the call so that through a suitable API, the subscriber desirous to finance (pay for) the call receives messages from the first wireless platform causing the subscriber's credit balance to decrement or debit balance to increment, as the case may be, and also cause the call to be channeled to the second wireless platform to permit completion of the call.

The account of a subscriber CR can be billed on a cash basis, on a fixed billing cycle such as monthly, charged against a bank balance, or any other suitable way. A subscriber can add cash to his account physically or electronically. All of this is programmed into the billing platform 20 that is operated by a suitably programmed computer. The second code number provides the rules by which the call is to be charged and the billing platform computer is programmed to associate the charging rule with the second code.

FIG. 2 shows a first embodiment of the invention. In S101, a caller originates a call from a different calling area from the one on which the call receiver resides or to which his billing platform is attached. These originating calling areas include but are not limited to any country, area code or state other than where the call terminates. A call is made to a call receiver CR using the first code and can be by dialing the telephone number of the call receiver or by entering a special code unique to the call receiver. The second code provides the call charging rules. Such second code could have been previously provided in S102 by the call receiver to the caller. Also, it can be made part of a call originated by a caller who dials the first code in other ways to be described below. In S105, the charges are automatically decremented from the account balance of the party being called by an amount determined by the rules of the second code. This will occur any time the call receiver is reached by a caller that has the appropriate second code. When a caller who does not have the second code calls a system subscriber, the charges for the call will be billed to the caller or to the service provider or to the receiver at a different rate for incoming domestic calls.

The billing platform 20 has the call receiving charge plan or plans associated with each system subscriber CR. The plan or plans are linked to the second code. A call having the appropriate second code of a call receiver is linked to the account of the call receiver in the billing platform and the account balance is charged or decremented in S107. The decrementing amount can be in any of the following forms or in any combination thereof: a fixed amount per call; an absolute amount determined in advance by the parties in question; an amount which can be associated to the pass-code in a database and which may be held by either the calling platform or the receiving platform; an amount that can be determined by Automatic Number Identification (“ANI”) of the party calling; an amount that is determined by the calling area code; an amount that is determined by the country of origin; an amount that is determined by the call receiving area code; an amount that is determined by a combination of the calling and/or receiving area codes; and an amount that is determined by the access number reached originally by the caller to reach the switching platform that channels the communication between the call originating and call receiving platform. Again, it is the Information in the second code that is associated with the rules for determining the amount to be decremented.

The call receiving party also may be using a pre-paid service that provides for the loading of airtime that could be attached to different decrementing schemes. The decrementing amount is based on the second code and can vary with the regular decrementing scheme that the pre-paid subscriber has at any given time. To illustrate this, consider that a call receiver loads a $15 dollar Rate Plan A amount into his account balance for regular $0.15 a minute calling rate, potentially giving him 100 minutes of regular airtime usage. Before the balance expires such call receiver might load another card for a $10 value with a Rate Plan B rate in which the regular airtime is $0.20 a minute. Therefore, the second $10 value gives the user another 50 minutes.

In an example of the above, an incremental rate or absolute special rate exists for a certain pre-appended caller-id or second code originating from a certain region, area code, or country. The different rate plans permit decrementing of the call receiver's account to be balanced in an appropriate manner. The balance may be decremented by First-in-First-Out (“FIFO”) basis or Last-in-First-Out basis (“LIFO”). So for example, under FIFO, first-in-first-out basis scheme, if the call receiver has used only five minutes from his balance under Plan A, then the Plan A rate is charged by the billing platform until the Plan A balance part of the account is depleted. After Plan A's balance part is fully used, the “special” pre-appended based caller-id rate will be the rate pre-defined for Plan B in the billing platform 20.

The dynamic manner in which the account of a subscriber is decremented for a received call, that is chargeable to his account based on the second code, applies to all of the embodiments of the invention.

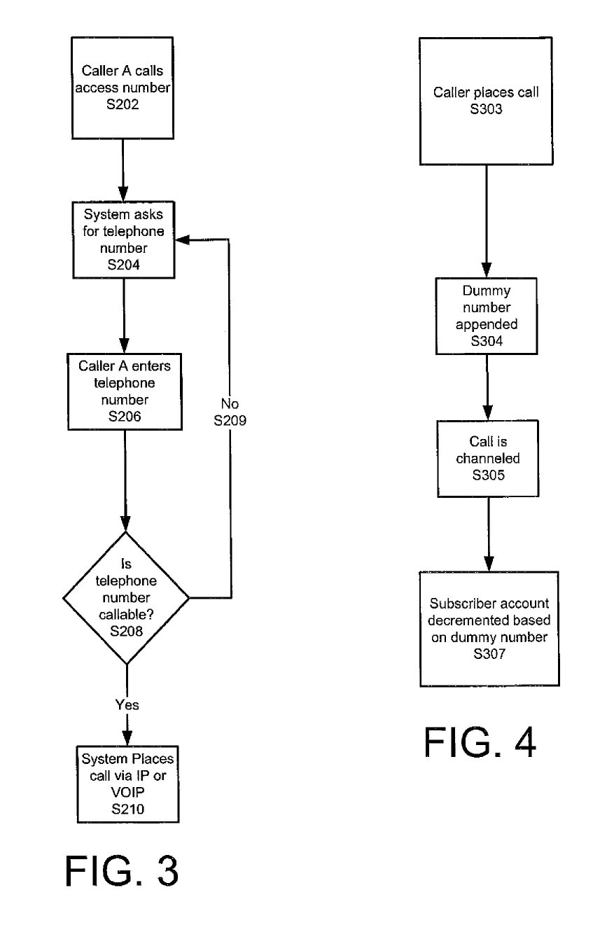

FIG. 3 is another embodiment of the invention in which a third party or a call receiving party controls the numbers that a calling party can call and have the charges accepted by the receiving party. In S202, a caller in a different country originates a call by calling an access number, which may be a “toll-free” number such as a 1-800 number. In S204 the system prompts the caller for the first code of a call receiving party that the caller wants to reach in the foreign country or other region. The caller can enter the first code identifying the receiving party and later be prompted for the second code that sets the charging amount rules or the second code can be appended by the service provider at the access number called. The first and second codes of parties that can be reached and charged have been previously uploaded into a database as cell phone numbers that are pre-paid, post-paid or a hybrid pre-paid/post-paid program. The list of codes for callers that can be reached can be supplied, for example, by an employer who issues a cell phone to an employee and only wants the employee to be able to contact certain telephone numbers on a charge accepted basis. Referring again to FIG. 1, the list of telephone numbers comprises a subset of the overall set of call-receiving parties in the subscriber system. Meanwhile, adjunct rules 17 operate upon calls received through the wireless platform 14 to bill a particular subscriber such as the employer when the call-receiving party is within the subset of calling parties. In other words, the employer can access the subscription system and add calling-parties that he or she is willing to pay for received calls. In this way, the employee can call designated recipients, and, likewise, a benefactor can cover the cost of phone calls made to a group of call recipients provided that the first and second codes are satisfied.

After the first code has been supplied by the caller, the system searches the previously populated database of code numbers to determine whether the code belongs to a party in the system 15 who can be called at no charge. If the number that the caller wants to reach is not in the database, the system prompts for the code again until a reachable code number as determined by the database is supplied. Once a reachable first code number has been supplied, the second code number is supplied by the caller or from the database or appended by a third party service provider. The system then channels the communication through any method of routing including but not limited to Internet Protocol (IP) or Voice over Internet Protocol (VIP) to the call receiver party. The account of the call receiver is decremented in the manner described above as set by the second code.

FIG. 4 shows a further embodiment if the invention in which the balance of the call receiving party's account is decremented an amount that is as a function of caller-ID information, this being the second code, which has been supplied by the calling party and which indicates the origination of the call. The caller ID is just a dummy number so that all that the wireless platform service provider 12 on the call receiver side would see, for example assuming a call originating from countries outside of the United States would be a number such as 903-230-0150 in the case of calls coming from Mexico, or 903-230-01-41 in the case of calls coming from Peru, etc. There is an assigned dummy number for each country, this being the second code. The caller-ID, or second code, also can be a special number assigned to a specific caller that is associated with charging the call receiver at a special calling rate or plan. That is, the caller has a specifically assigned second code to set the calling amount that the call receiver is to be charged.

In S303 the party places a call to a call receiving party, this being the first code. In S304 the caller-ID or dummy number is appended to the calling number. This can be done by the caller or the service provider on the caller side. As another possibility the caller can first call a local or 800 number that will append the caller-ID dummy number or second code to number being called. Considering that the call has been channeled in S305 to the call receiver platform 15, in S307 the billing platform 20 decrements the call receivers account based on the appended caller-ID second code. That is, the appended caller-ID enables the billing platform to decrement the balance of the call receiver based on the country of call origin as identified in the caller-ID or dummy number. There can be different rates for different countries as initiated by the second code. The charges made to a call receiver can dynamically vary based on second codes as received from different callers.

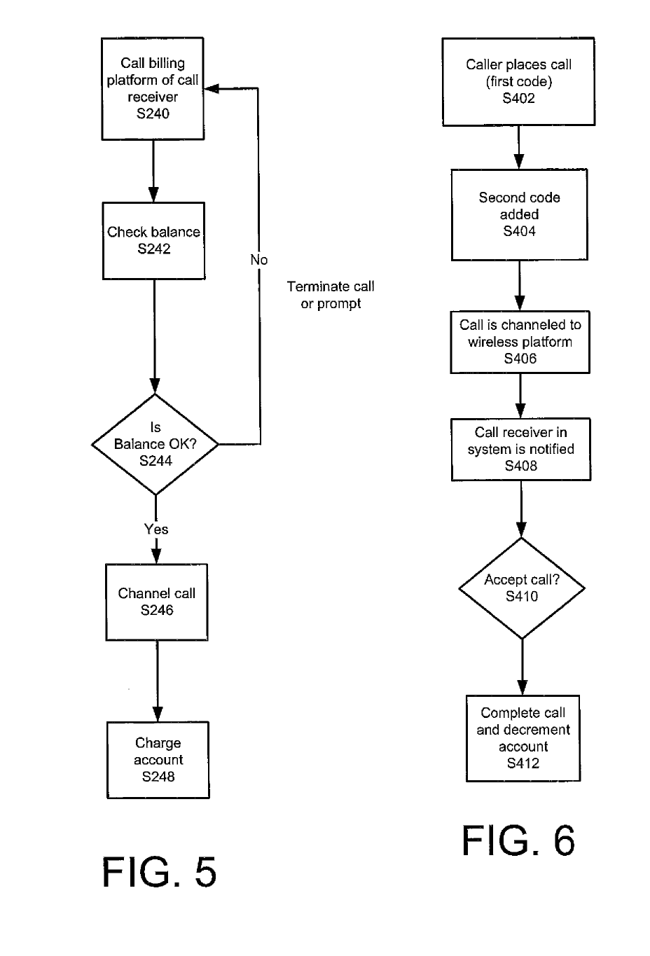

FIG. 5 describes a variation that can be used with any of the embodiments of the invention. Here, prior to the caller side actually channeling the call to the destination or call receiving party, the system in S240 sends an IP system call via an Application Programming Interface (API) system call to the billing platform 20 of the call receiving party. The call being made can be either pre-paid or post-paid. In S242 the billing platform 20 checks the account balance of the call receiver's account so that the calling system is aware, before having to channel the call to the receiving party, whether the call receiving party has a sufficient balance to receive the call. If it is determined in S244 that the balance is not sufficient to receive the call then the call is terminated and the caller is advised.

In this variation when it is determined that a subscriber has no balance he is effectively stopped from receiving calls for which he will be charged. This is another dynamic aspect of the subscriber system 15. The call receiver with a low balance or no balance or one who is now blocked from receiving chargeable calls can be prompted of this. As described above, a prompt also can be sent to the caller.

If it is determined in S244 that the call receiving party does have a sufficient balance for the call, then the calling system service provider in S246 channels the call (enables the call to be directed and connected) to the receiving party. The receiving party's billing platform 20 in S248 decrements the balance of the receiving party according to the appended caller-ID or dummy number, the second code in any of the ways described with respect to FIG. 2, typically in relation to the length of the call plus any call connection charges.

In a variation of the technique of FIG. 5, the calling platform channels the call to the receiving platform 15 without actually verifying that the call receiving party has a sufficient balance to receive the call from the calling party. If the call receiver does not have a sufficient balance, then the caller side service provider 12 would have incurred a cost since there would not be a call receiver account balance to decrement against for the charges associated with the call. The service provider can supply the service regardless because in the aggregate the service provider eventually expects a profit for the incremental use of the cell phone by the receiving party if such service is offered.

In yet another variation, the receiving party's billing platform 20 does not actually decrement the balance of the receiving party, but the service provider on the receiving party side instead bears the risk of giving access to the calling party with the expectation of the receiving party utilizing the service more often than it would otherwise for having that feature available.

The variation of checking the receiving party's account balance for sufficient funds before the call is passed on to the receiving party can be applied to all of the embodiments of the invention.

FIG. 6 shows another variation that can be used with any of the embodiments of the invention. Here, following the general scheme of the embodiment of FIG. 4 as an example, in S402 a caller places a call to a call receiver by dialing the first code. In S404 the second code or dummy number is appended. This can be done by the caller or the second code can be appended by the caller side service provider, or appended by an 800 type number that the caller dials into at which he also might be required to enter the first code before the second code is appended.

In S406 the call is channeled to the wireless platform 14 on the receiving party side. In S408 the wireless platform notifies the call receiver in the system 15 being called that someone is trying to make a call to him that will be chargeable to him. In S410 the caller is given the option of accepting or rejecting the incoming call. If the call receiving party has a caller identification (caller ID) function associated with his telephone, then he can identify the calling party. The call receiving party accepts or rejects the call. He does this by pressing a predetermined key, like 1 for yes and 2 for no, whose data code is sent to the wireless platform 14. If the call is accepted then it is routed to him by the wireless platform 14 the charge for the call is decremented from the call receivers account based on the call charging rate rules of the second code as described above. If the call receiving party rejects the call, in S411 the calling party is notified of the rejection. This can be done by the wireless platform notifying the caller directly or notifying the service provider on the caller's side who then notifies the caller.

The accepting or rejection of a call in S410 can be automated. Here the wireless platform 14 would have a database of acceptable (or non-acceptable) callers that is set up by the call receiving party. An incoming call is checked against the database and accepted or rejected after being checked against the database list. An accepted call is routed to the call receiver and a rejected call is refused a described above.

Specific features of the invention are shown in one or more of the drawings for convenience only, as each feature may be combined with other features in accordance with the invention. Alternative embodiments will be recognized by those skilled in the art and are intended to be included within the scope of the claims. Accordingly, the above description should be construed as illustrating and not limiting the scope of the invention. All such obvious changes and modifications are within the patented scope of the appended claims.

I claim:

1. A method of managing airtime values for a call to be charged in a system of call receiving parties including one or more subscribers, comprising:
receiving the call directed to a call receiving party from a caller in which both a first code that identifies the call receiving party and a second code are applied by the caller;
establishing rules associated with the second code that determine by what amount the received call is to be charged; and
charging one of the subscribers in the subscription system that is associated with said first code for the cost of the received call by an amount determined by the rules associated with said second code.

2. The method as claimed in claim 1 wherein the said one of the subscribers is the call receiving party.

3. The method as claimed in claim 2 further comprising the steps of:
establishing an account for the call receiving party; and
decrementing the account of the call receiving party by the amount charged for the call.

4. The method as claimed in claim 1 wherein said first code is the telephone number of the party being called.

5. The method as claimed in claim 1 wherein said one of the subscribers is associated with the first code by the further steps of:
including in a database identifying information concerning the call receiving party;
storing the identifying information in relation to an account of said one of the subscribers.

6. The method as claimed in claim 1 wherein said second code identifies the region from where the received call is placed and the rules for call charging associated with said second code include charging based on the country where the received call was placed.

7. The method as claimed in claim 1 wherein said second code is applied to the received call by the party placing the received call.

8. The method as claimed in claim 1 wherein the second code is applied by a third party.

9. The method as claimed in claim 1 wherein a party placing a call first calls a number of third party and further comprising the step of the third party applying said second code.

10. The method as claimed in claim 8 wherein said second code identifies the region from where the received call is placed and the rules for call charging associated with said second code include charging based on the country where the received call is placed.

11. The method as claimed in claim 3 further comprising the step of checking the balance of the account of the subscriber associated with the received call to determine if there is an adequate balance against which the call can be charged before the received call can be connected to the call receiver.

12. The method as claimed in claim 11 wherein the received call from a call originating region is communicated by a service provider, the method including the additional step of a service provider connecting the received call without there being an adequate balance against which the received call can be charged.

13. The method as claimed in claim 1 further comprising the step of a third party supplying a calling party with a list of first and second codes of call receiving parties that the calling party can call and have charges for the received call accepted.

14. The method as claimed in claim 1 further comprising the step of a call receiving party accepting or rejecting a call having a second code that is placed to him.

15. The method as claimed in claim 14 wherein at least one of the subscribers establishes a database list of received calls having second codes that are to be accepted for the charging step and further comprising the steps of checking incoming calls against the database list and rejecting received calls from callers not on the database list.

16. A system for managing airtime values for a call to be charged to a subscriber thereof, comprising:
a calling platform from which a call is placed to a call receiving party by applying both a first code that identifies a call receiving party and a second code;
a call receiving platform for receiving calls placed from said calling platform and having a system of call receiving party subscribers at least one of which is associated with the first code; and
a billing platform linked to said call receiving platform that operates based on rules associated with the second code to determine by what amount a received call is to be charged and that charges the subscriber associated with said first code for the cost of the received call by an amount determined by the rules associated with said second code.

17. The system as claimed in claim 16 wherein said subscriber is the call-receiving party and wherein said billing platform establishes an account for the call-receiving party and decrements the account of the call-receiving party by the amount charged for the call.

18. The system as claimed in claim 16 wherein said calling platform appends said second code to a call as a designation of the origin of the call and said billing platform charges for the call based on its place of origination in accordance with the rules associated with said second code.

19. The system as claimed in claim 18 wherein a third part appends the second code to the call at the billing platform.

20. The system as claimed in claim 17 wherein one of said calling platform and said call receiving platform checks the balance of the call receiving party subscriber before the call is routed to the call receiving party by the call receiving platform.

21. The system as claimed in claim 16 wherein said call receiving platform also refuses to accept a call having a second code placed by a caller.
